(19) United States
(12) Patent Application Publication
(10) Pub. No.: US 2013/0113316 A1
(43) Pub. Date: May 9, 2013

(54) BEARING ASSEMBLY AND MOTOR INCLUDING THE SAME

(71) Applicants: Sang Jin Park, Hwaseong (KR); Ta Kyoung Lee, Hwaseong (KR)

(72) Inventors: Sang Jin Park, Hwaseong (KR); Ta Kyoung Lee, Hwaseong (KR)

(73) Assignee: Samsung Electro-Mechanics Co., Ltd., Suwon (KR)

(21) Appl. No.: 13/358,981

(22) Filed: Jan. 26, 2012

(30) Foreign Application Priority Data
Nov. 3, 2011 (KR) 10-2011-0113679

(51) Int. Cl. F16C 32/06; H02K 7/08

(52) U.S. Cl. 310/90; 384/118

(57) ABSTRACT

There is provided a bearing assembly including: herringbone-shaped first and second fluid dynamic pressure parts formed in upper and lower portions of at least one of an outer peripheral surface of a shaft and an inner peripheral surface of a sleeve in an axial direction to be spaced apart from each other; and a first auxiliary fluid dynamic pressure part formed to be bent upwardly from an end portion of a lower groove of the herringbone-shaped first fluid dynamic pressure part in an axial direction.

### CROSS-REFERENCE TO RELATED APPLICATIONS

This application claims the priority of Korean Patent Application No. 10-2011-0113679 filed on Nov. 3, 2011, in the Korean Intellectual Property Office, the disclosure of which is incorporated herein by reference.

### BACKGROUND OF THE INVENTION

1. Field of the Invention

The present invention relates to a bearing assembly and a motor including the same, and more particularly, to a motor capable of being used in a hard disk drive (HDD) rotating a recording disk.

2. Description of the Related Art

A hard disk drive (HDD), an information storage device, reads data stored on a disk or writes data to the disk using a read/write head.

The hard disk drive requires a disk driving device capable of driving the disk. In the disk driving device, a spindle motor is used.

In the spindle motor, a fluid dynamic pressure bearing assembly has commonly been used. A shaft, a rotating member of the fluid dynamic pressure bearing assembly, and a sleeve, a fixed member thereof, include oil interposed therebetween, such that the shaft is supported by fluid pressure generated in the oil.

That is, a spindle motor as described above uses dynamic pressure via the oil in order to support rotation of the rotating member. In order to generate this dynamic pressure, the rotating member or the fixed member includes dynamic pressure generating grooves formed in upper and lower portions thereof.

However, in the case in which the rotating member rotates through the application of power thereto, pressure directed upwardly and downwardly is instantaneously generated between the dynamic pressure generating grooves, such that negative pressure may be generated therebetween.

This causes the generation of gas bubbles, which may hinder the performance of the spindle motor.

Therefore, research into a technology for significantly increasing the performance and lifespan of a spindle motor by suppressing the generation of negative pressure at the time of the operation of the spindle motor is urgently required.

### SUMMARY OF THE INVENTION

An aspect of the present invention provides a bearing assembly having improved bearing rigidity by increasing a bearing span length, and having significantly increased performance and lifespan by preventing negative pressure between a rotating member and a fixed member, and a spindle motor including the same.

According to an aspect of the present invention, there is provided a bearing assembly including: a sleeve supporting a shaft; herringbone-shaped first and second fluid dynamic pressure parts formed in upper and lower portions of at least one of an outer peripheral surface of the shaft and an inner peripheral surface of the sleeve in an axial direction to be spaced apart from each other, so as to generate dynamic pressure via a lubricating fluid filled between the shaft and the sleeve; and a first auxiliary fluid dynamic pressure part formed to be bent upwardly from an end portion of a lower groove of the herringbone-shaped first fluid dynamic pressure part in an axial direction.

The first auxiliary fluid dynamic pressure part may be provided in parallel with an upper groove of the herringbone-shaped first fluid dynamic pressure part.

The first auxiliary fluid dynamic pressure part may be spaced apart from the lower groove of the herringbone-shaped first fluid dynamic pressure part neighboring thereto.

The bearing assembly may further include a second auxiliary fluid dynamic pressure part formed to be bent downwardly from an end portion of an upper groove of the herringbone-shaped second fluid dynamic pressure part in the axial direction.

The second auxiliary fluid dynamic pressure part may be provided in parallel with a lower groove of the herringbone-shaped second fluid dynamic pressure part.

The second auxiliary fluid dynamic pressure part may be spaced apart from the upper groove of the herringbone-shaped second fluid dynamic pressure part neighboring thereto.

According to another aspect of the present invention, there is provided a bearing assembly including: a sleeve supporting a shaft; herringbone-shaped first and second fluid dynamic pressure parts formed in upper and lower portions of at least one of an outer peripheral surface of the shaft and an inner peripheral surface of the sleeve in an axial direction to be spaced apart from each other, so as to generate dynamic pressure via a lubricating fluid filled between the shaft and the sleeve; and a second auxiliary fluid dynamic pressure part formed to be bent downwardly from an end portion of an upper groove of the herringbone-shaped second fluid dynamic pressure part in an axial direction.

The second auxiliary fluid dynamic pressure part may be provided in parallel with a lower groove of the herringbone-shaped second fluid dynamic pressure part.

The second auxiliary fluid dynamic pressure part may be spaced apart from the upper groove of the herringbone-shaped second fluid dynamic pressure part.

According to another aspect of the present invention, there is provided a spindle motor including: the bearing assembly of any one of claims 1 to 9; a base having the sleeve and a core coupled thereto, the core having a coil wound therearound; and a hub operating together with the shaft and including a magnet.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor including a bearing assembly according to an embodiment of the present invention;

FIG. 2 is a schematic cut-away perspective view showing a sleeve provided in the bearing assembly according to the embodiment of the present invention;

FIG. 3 is a schematic enlarged cross-sectional view of part X of FIG. 1 provided in order to describe a pressure generation direction by first and second fluid dynamic pressure parts and a first auxiliary fluid dynamic pressure part at the time of rotation of a shaft;

FIG. 4 is a schematic cut-away perspective view showing a sleeve provided in a bearing assembly according to another embodiment of the present invention;

FIG. 5 is a schematic enlarged cross-sectional view of part X of FIG. 1 according to another embodiment of the present invention provided in order to describe a pressure generation direction by first and second fluid dynamic pressure parts and a second auxiliary fluid dynamic pressure part at the time of rotation of a shaft;

FIG. 6 is a schematic cut-away perspective view showing a sleeve provided in a bearing assembly according to another embodiment of the present invention; and

FIG. 7 is a schematic enlarged cross-sectional view of part X of FIG. 1 according to another embodiment of the present invention provided in order to describe a pressure generation direction by first and second fluid dynamic pressure parts and first and second auxiliary fluid dynamic pressure parts at the time of rotation of a shaft.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

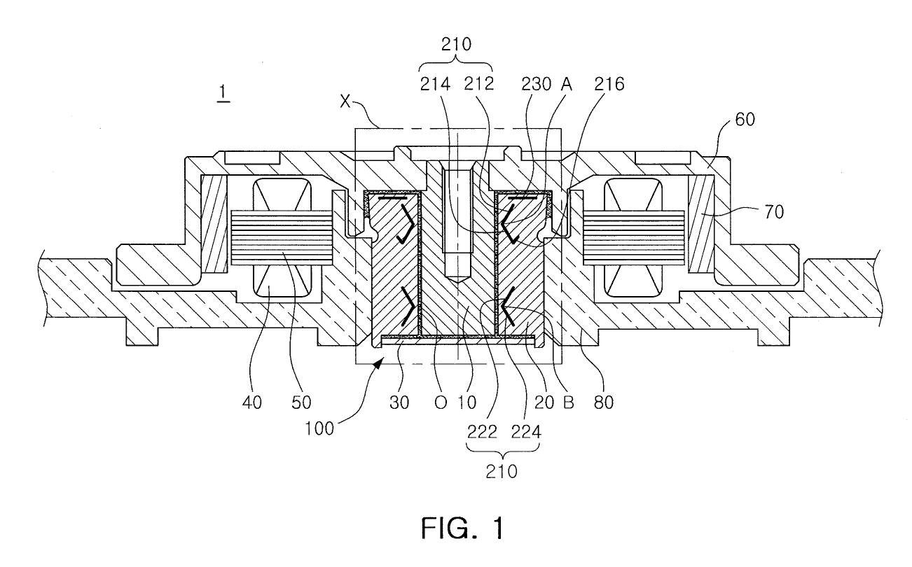

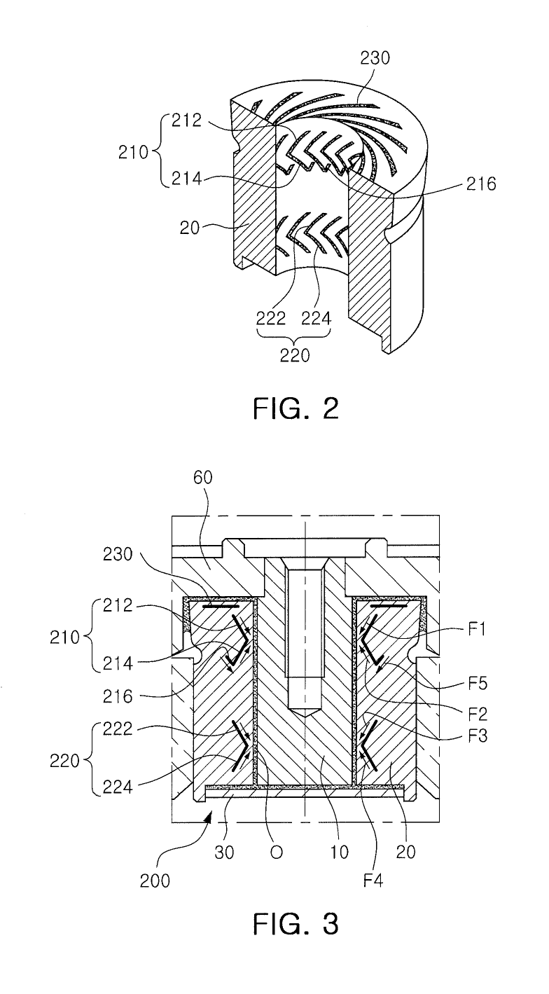

FIG. 1 is a schematic cross-sectional view showing a spindle motor including a bearing assembly according to an embodiment of the present invention. FIG. 2 is a schematic cut-away perspective view showing a sleeve provided in the bearing assembly according to the embodiment of the present invention. FIG. 3 is a schematic enlarged cross-sectional view of part X of FIG. 1 provided in order to describe a pressure generation direction by first and second fluid dynamic pressure parts and a first auxiliary fluid dynamic pressure part at the time of rotation of a shaft.

Referring to FIG. 1, a spindle motor 1 including a bearing assembly 100 according to an embodiment of the present invention may include the bearing assembly 100 including a shaft 10 and a sleeve 20; a base 80 having a core 50 coupled thereto, the core 50 having a coil 40 wound therearound; and a hub 60 having a magnet 70.

Terms with respect to directions will be first defined. As viewed in FIG. 1, an axial direction refers to a vertical direction based on the shaft 10, and an outer diameter or inner diameter direction refers to a direction towards an outer edge of the hub 60 based on the shaft 10 or a direction towards the center of the shaft 10 based on the outer edge of the hub 60.

The bearing assembly 100 may include the shaft 10 and the sleeve 20, and each of the shaft 10 and the sleeve 20 may be a component of a rotating member and a fixed member.

The sleeve 20, a component supporting the shaft 10, may support the shaft 10 such that an upper end of the shaft 10 protrudes upwardly in the axial direction and may be formed by forging Cu or Al or sintering a Cu—Fe based alloy powder or a steel use stainless (SUS) based power.

In addition, the sleeve 20 may include a shaft hole having the shaft 10 inserted thereinto such that the sleeve 20 and the shaft 10 have a micro clearance therebetween, and the micro clearance may be filled with a lubricating fluid O to thereby stably support the shaft 10 by dynamic pressure via the lubricating fluid O .

Here, the dynamic pressure via the lubricating fluid O may be generated by first and second fluid dynamic pressure parts 210 and 220 formed in upper and lower portions of at least one of an outer peripheral surface of the shaft 10 and an inner peripheral surface of the sleeve 20 to be spaced apart from each other.

That is, the first and second fluid dynamic pressure parts 210 and 220 may be grooves each having a herringbone shape and generate the dynamic pressure via the lubricating fluid O when the rotating member including the shaft 10 rotates by electromagnetic interaction between the coil 40 and the magnet 70 though application of power to the coil 40.

Meanwhile, the first and second fluid dynamic pressure parts 210 and 220 may include upper grooves 212 and 222 and lower grooves 214 and 224, and the upper grooves 212 and 222 and the lower grooves 214 and 224 may be symmetrical to each other based on a boundary.

However, the upper grooves 212 and 222 and the lower grooves 214 and 224 are not necessarily symmetrical to each other based on a boundary but may be variously modified according to design intention of those skilled in the art.

Here, as shown in FIG. 3, when the shaft 10 starts to rotate, the lubricating fluid O filled between the shaft 10 and the sleeve 20 may be collected in a boundary between the upper and lower grooves 212 and 214 of the first fluid dynamic pressure part 210, which is a bent point A of the first fluid dynamic pressure part 210, and in a boundary between the upper and lower grooves 222 and 224 of the second fluid dynamic pressure part 220, which is a bent point B of the second fluid dynamic pressure part 220.

In other words, when the shaft 10 rotates, the bearing assembly according to the embodiment of the present invention may generate pressures F1 to F4 directed toward the bent points A and B via the lubricating fluid O by the first and second fluid dynamic pressure parts 210 and 220, which are the grooves each having the herringbone shape.

Here, force directed upwardly in the axial direction and force directed downwardly in the axial direction are simultaneously applied to the lubricating fluid O filled between the first and second fluid dynamic pressure parts 210 and 220 by pressure F2 generated by the lower groove 214 of the first fluid dynamic pressure part 210 and pressure F3 generated by the upper groove 222 of the second fluid dynamic pressure part 220 among pressures F1 to F4 directed toward the bent points A and B of the first and second fluid dynamic pressure parts 210 and 220.

Here, due to the above-mentioned phenomenon, (−) pressure, which is pressure lower than atmospheric pressure, that is, negative pressure may be generated in a space between the first and second fluid dynamic pressure parts 210 and 220.

Once the (−) pressure, which is the pressure lower than atmospheric pressure, that is, the negative pressure is generated between the shaft 10 and the sleeve 20, air components contained in the lubricating fluid O generate air bubbles due to the low pressure.

These air bubbles may be introduced into the first and second fluid dynamic pressure parts 210 and 220 or a thrust dynamic pressure part 230 to be described below to thereby allow normal dynamic pressure not to be generated, such that vibrations and noise are caused and rotational characteristics are deteriorated.

However, the bearing assembly 100 according to the embodiment of the present invention may prevent the possibility that the air bubbles will be generated as described above, in advance by a first auxiliary fluid dynamic pressure part 216.

A structural feature of the first auxiliary fluid dynamic pressure part 216 will be first described. The first auxiliary fluid dynamic pressure part 216 may be bent upwardly from an end portion of the lower groove 214 of the first dynamic pressure part 210 having the herringbone shape in the axial direction.

In addition, the first auxiliary fluid dynamic pressure part 216 may be provided in parallel with the upper groove 212 of the first dynamic pressure part 210 and provided to be spaced apart from the lower groove 214 of the first fluid dynamic pressure part 210 neighboring thereto.

Therefore, when the shaft 10 rotates, pressure F5 directed toward a boundary between the lower groove 214 of the first fluid dynamic pressure part 210 and the first auxiliary fluid dynamic pressure part 216 may be generated by the first auxiliary fluid dynamic pressure part 216.

That is, pressure F5 directed toward the boundary between the lower groove 214 of the first fluid dynamic pressure part 210 and the first auxiliary fluid dynamic pressure part 216 may provide force directed between the first and second fluid dynamic pressure parts 210 and 220 to the lubricating oil O .

This force may serve to prevent the possibility that the negative pressure will be generated due to pressure F2 generated by the lower groove 214 of the first fluid dynamic pressure part 210 and pressure F3 generated by the upper groove 222 of the second fluid dynamic pressure part 220 in advance.

Therefore, the possibility of negative pressure generation at the time of rotation of the shaft 10 is prevented in advance, such that the possibility of air bubbles generation may also be prevented in advance.

In addition, in the bearing assembly 100 according to the embodiment of the present invention, bearing rigidity may be improved by the first auxiliary fluid dynamic pressure part 216.

That is, in the case of a spindle motor according to the related art, a structure of fluid dynamic pressure parts is changed in order to prevent the above-mentioned negative pressure.

In other words, in the case of the spindle motor according to the related art, an upper groove of an upper fluid dynamic pressure part is formed to have a length longer than that of a lower groove thereof and a lower groove of a lower fluid dynamic pressure part is formed to have a length longer than that of an upper groove thereof, thereby preventing the negative pressure.

Therefore, in the spindle motor according to the related art, a bearing span length is reduced due to the structure of the fluid dynamic pressure parts as described above, such that bearing rigidity is weakened.

Here, the bearing span length means a distance between points at which the highest pressure is generated by the upper fluid dynamic pressure part and the lower fluid dynamic pressure part, that is, a distance between bent points of the fluid dynamic pressure parts.

Meanwhile, the bearing assembly 100 according to the embodiment of the present invention may prevent the generation of the negative pressure in advance by the first auxiliary fluid dynamic pressure part 216, regardless of the structure of the first and second fluid dynamic pressure parts 210 and 220, whereby the bearing span length may be increased as compared to the case of the spindle motor according to the related art.

As a result, in the bearing assembly 100 according to the embodiment of the present invention, the bearing rigidity may be improved as compared to the case of the spindle motor according to the related art.

In addition, the sleeve 20 may include a thrust dynamic pressure part 230 formed in an upper surface thereof so as to generate thrust dynamic pressure via the oil O . The rotating member including the shaft 10 may rotate in a state in which a predetermined floating force is secured by the thrust dynamic pressure part 230.

Here, the thrust dynamic pressure part 230 may be a groove having a herringbone shape, a spiral shape, or a screw shape. However, the thrust dynamic pressure part 224 is not limited to having the above-mentioned shapes but may have any shape as long as the thrust dynamic pressure may be provided thereby.

In addition, the thrust dynamic pressure part 230 is not limited to being formed in the upper surface of the sleeve 20 but may also be formed in one surface of the hub 60 corresponding to the upper surface of the sleeve 20.

Further, the sleeve 20 may include a base cover 30 coupled to a lower portion thereof so as to close the lower portion thereof. The spindle motor 10 according to the embodiment of the present invention may be formed to have a full-fill structure by the base cover 30.

The hub 60 may be a component of the rotating member rotatably provided with respect to the fixed member including the base 80.

In addition, the hub 60 may include an annular ring shaped magnet 70 provided on an inner peripheral surface thereof, the annular ring shaped magnet 70 corresponding to the core 50 while having a predetermined interval therebetween.

Here, the magnet 70 may generate rotational driving force of the spindle motor 1 according to the embodiment of the present invention by electromagnetic interaction between the coil 40 wound around the core 50 and the magnet 70.

The base 80 may be a component of the fixed member supporting rotation of the rotating member including the shaft 10 and the hub 60 with respect to the rotating member.

Here, the base 80 may include the core 50 coupled thereto, the core 50 having the coil 40 wound therearound. The core 50 may be fixedly disposed on an upper portion of the base 80 including a printed circuit board (not shown) having pattern circuits printed thereon.

In other words, an outer peripheral surface of the sleeve 20 and the core 50 having the coil 40 wound therearound may be inserted into the base 80, such that the sleeve 20 and the core 50 may be coupled to the base 80.

Here, as a method of coupling the sleeve 20 and the core 50 to the base 80, a bonding method, a welding method, a press-fitting method, or the like, may be used. However, a method of coupling the sleeve 20 and the core 50 to the base 80 is not necessarily limited thereto.

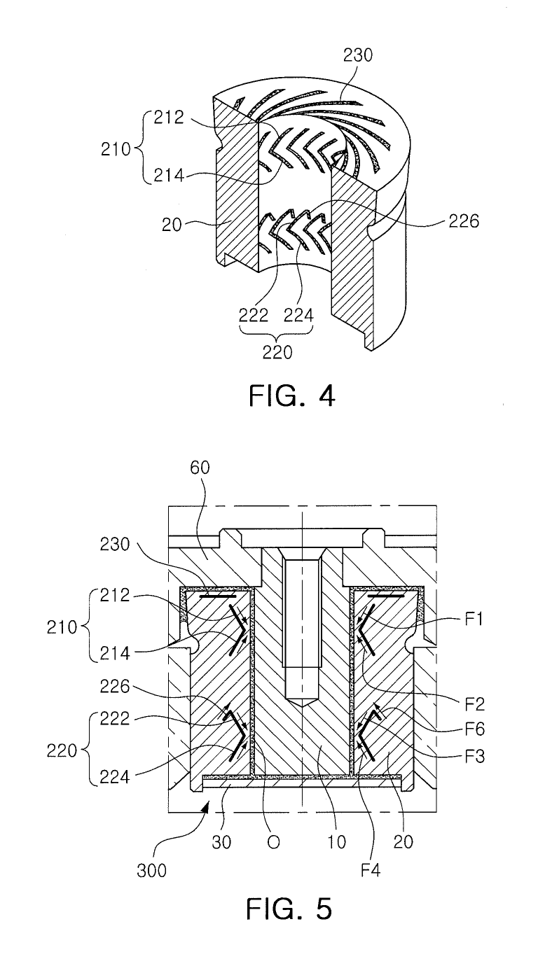

FIG. 4 is a schematic cut-away perspective view showing a sleeve provided in a bearing assembly according to another embodiment of the present invention. FIG. 5 is a schematic enlarged cross-sectional view of part X of FIG. 1 according to another embodiment of the present invention provided in order to describe a pressure generation direction by first and second fluid dynamic pressure parts and a second auxiliary fluid dynamic pressure part at the time of rotation of a shaft.

Referring to FIGS. 4 and 5, a bearing assembly 300 according to another embodiment of the present invention may include the first and second fluid dynamic pressure parts 210 and 220 formed in at least one of the outer peripheral surface of the shaft 10 and the inner peripheral surface of the sleeve 20, similar to the bearing assembly 100 according to the embodiment of the present invention described above.

However, the bearing assembly 300 according to another embodiment of the present invention 300 may include a second auxiliary fluid dynamic pressure part 226 bent downwardly from the upper groove 222 of the second fluid dynamic pressure part 220 having the herringbone shape in the axial direction.

The second auxiliary fluid dynamic pressure part 226 may be provided in parallel with the lower groove 224 of the second dynamic pressure part 220 and provided to be spaced apart from the upper groove 222 of the second fluid dynamic pressure part 220 neighboring thereto.

Therefore, when the shaft 10 rotates, pressure F6 directed toward a boundary between the upper groove 222 of the second fluid dynamic pressure part 220 and the second auxiliary fluid dynamic pressure part 226 may be generated by the second auxiliary fluid dynamic pressure part 226.

That is, pressure F6 directed toward the boundary between the upper groove 222 of the second fluid dynamic pressure part 220 and the second auxiliary fluid dynamic pressure part 226 may provide force directed between the first and second fluid dynamic pressure parts 210 and 220 to the lubricating oil O .

As a result, this force may serve to prevent the possibility that the negative pressure will be generated due to pressure F2 generated by the lower groove 214 of the first fluid dynamic pressure part 210 and pressure F3 generated by the upper groove 222 of the second fluid dynamic pressure part 220, in advance.

Therefore, the possibility of negative pressure generation at the time of rotation of the shaft 10 is prevented in advance, such that the possibility that the air bubbles will be generated may also be prevented in advance.

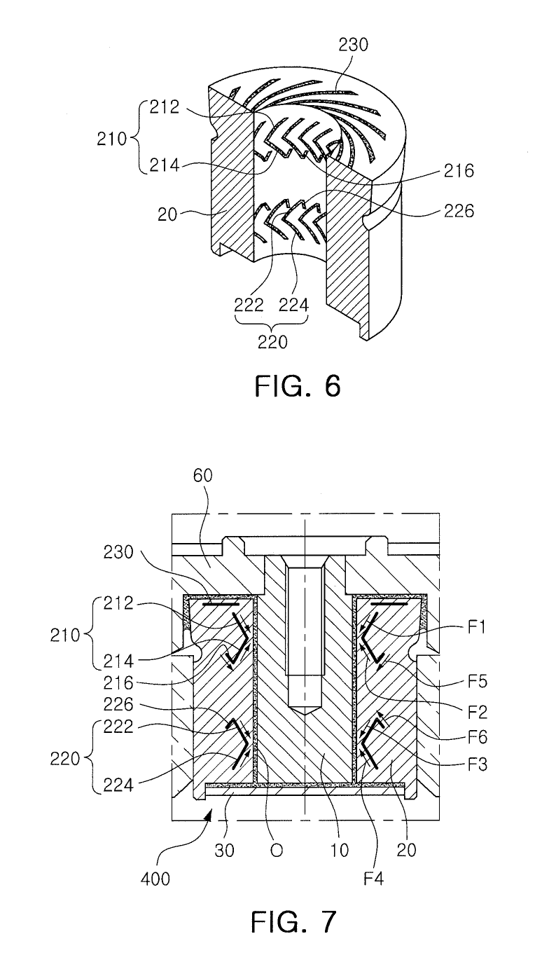

FIG. 6 is a schematic cut-away perspective view showing a sleeve provided in a bearing assembly according to another embodiment of the present invention. FIG. 7 is a schematic enlarged cross-sectional view of part X of FIG. 1 according to another embodiment of the present invention provided in order to describe a pressure generation direction by first and second fluid dynamic pressure parts and first and second auxiliary fluid dynamic pressure parts at the time of rotation of a shaft.

Referring to FIGS. 6 and 7, in a bearing assembly 400 according to another embodiment of the present invention, both of the first and second auxiliary fluid dynamic pressure parts 216 and 226 described above may be formed.

Therefore, when the shaft 10 rotates, pressure F5 directed toward the boundary between the lower groove 214 of the first fluid dynamic pressure part 210 and the first auxiliary fluid dynamic pressure part 216 and pressure F6 directed toward the boundary between the upper groove 222 of the second fluid dynamic pressure part 220 and the second auxiliary fluid dynamic pressure part 226 maybe simultaneously generated by the first and second auxiliary fluid dynamic pressure parts 216 and 226.

That is, the first and second auxiliary fluid dynamic pressure grooves 216 and 226 may provide the lubricating fluid O with force directed between the first and second fluid dynamic pressure parts 210 and 220.

This force prevents the possibility that the negative pressure will be generated between the shaft 10 and the sleeve 20 in advance, such that the possibility that the air bubbles will be generated may also be prevented in advance.

As set forth above, with a bearing assembly and a spindle motor including the same according to the embodiments of the present invention, the generation of negative pressure between a shaft, which is a rotating member, and a sleeve, which is a fixed member could be prevented in advance.

In addition, a bearing span length is significantly increased, whereby bearing rigidity could be significantly increased.

While the present invention has been shown and described in connection with the embodiments, it will be apparent to those skilled in the art that modifications and variations can be made without departing from the spirit and scope of the invention as defined by the appended claims.

What is claimed is:

1. A bearing assembly comprising:
a sleeve supporting a shaft;
herringbone-shaped first and second fluid dynamic pressure parts formed in upper and lower portions of at least one of an outer peripheral surface of the shaft and an inner peripheral surface of the sleeve in an axial direction to be spaced apart from each other, so as to generate dynamic pressure via a lubricating fluid filled between the shaft and the sleeve; and
a first auxiliary fluid dynamic pressure part formed to be bent upwardly from an end portion of a lower groove of the herringbone-shaped first fluid dynamic pressure part in an axial direction.

2. The bearing assembly of claim 1, wherein the first auxiliary fluid dynamic pressure part is provided in parallel with an upper groove of the herringbone-shaped first fluid dynamic pressure part.

3. The bearing assembly of claim 1, wherein the first auxiliary fluid dynamic pressure part is spaced apart from the lower groove of the herringbone-shaped first fluid dynamic pressure part neighboring thereto.

4. The bearing assembly of claim 1, further comprising a second auxiliary fluid dynamic pressure part formed to be bent downwardly from an end portion of an upper groove of the herringbone-shaped second fluid dynamic pressure part in the axial direction.

5. The bearing assembly of claim 4, wherein the second auxiliary fluid dynamic pressure part is provided in parallel with a lower groove of the herringbone-shaped second fluid dynamic pressure part.

6. The bearing assembly of claim 4, wherein the second auxiliary fluid dynamic pressure part is spaced apart from the upper groove of the herringbone-shaped second fluid dynamic pressure part neighboring thereto.

7. A bearing assembly comprising:
a sleeve supporting a shaft;
herringbone-shaped first and second fluid dynamic pressure parts formed in upper and lower portions of at least one of an outer peripheral surface of the shaft and an inner peripheral surface of the sleeve in an axial direction to be spaced apart from each other, so as to generate dynamic pressure via a lubricating fluid filled between the shaft and the sleeve; and
a second auxiliary fluid dynamic pressure part formed to be bent downwardly from an end portion of an upper groove of the herringbone-shaped second fluid dynamic pressure part in an axial direction.

8. The bearing assembly of claim 7, wherein the second auxiliary fluid dynamic pressure part is provided in parallel with a lower groove of the herringbone-shaped second fluid dynamic pressure part.

9. The bearing assembly of claim 7, wherein the second auxiliary fluid dynamic pressure part is spaced apart from the upper groove of the herringbone-shaped second fluid dynamic pressure part.

10. A spindle motor comprising:
the bearing assembly of claim 1;
a base having the sleeve and a core coupled thereto, the core having a coil wound therearound; and
a hub operating together with the shaft and including a magnet.
